(19) United States
(12) Patent Application Publication
(10) Pub. No.: US 2026/0011173 A1
(43) Pub. Date: Jan. 8, 2026

(54) SYSTEM AND METHOD FOR AUTOMATED MAINTENANCE AND OPTIMIZATION OF SWIMMING POOLS

(71) Applicant: Nuvis Technologies Inc., Mississauga (CA)

(72) Inventors: Anton GomÃ Huguet, Cervera (ES); Damodar Arapakota, Mississauga (CA)

(73) Assignee: Nuvis Technologies Inc., Mississauga (CA)

(21) Appl. No.: 19/034,849

(22) Filed: Jan. 23, 2025

Related U.S. Application Data
(60) Provisional application No. 63/667,918, filed on Jul. 5, 2024.

(51) Int. Cl. G06V 40/10; E04H 4/12; G06V 10/70

(52) U.S. Cl. CPC G06V 40/103; E04H 4/1209; E04H 4/1281; G06V 10/70

(57) ABSTRACT

The various embodiments herein provide a system and method for optimizing swimming pool maintenance by using advanced computer vision and machine learning technologies to detect real- time occupancy. The system employs high-definition cameras to continuously monitor the pool area, with an image processing unit analyzing the footage using sophisticated machine learning algorithms to accurately detect the number of swimmers. This data is utilized by a control unit to dynamically adjust maintenance parameters, ensuring optimal water quality and resource efficiency. Integrated sensors continuously monitor water conditions, providing feedback to further refine system operations. This innovative approach not only improves water safety and swimmer satisfaction by maintaining ideal conditions but also reduces operational costs and environmental impact by minimizing unnecessary chemical and energy use. The system's ability to integrate seamlessly with existing infrastructure and provide actionable insights through data analysis makes it a cutting-edge solution for modern pool maintenance needs.

### CROSS-REFERENCE TO RELATED APPLICATIONS

The embodiments herein claim the priority of the US Provisional Patent Application filed on Jul. 5, 2024, with the number 63/667,918 and titled, “SYSTEM AND METHOD FOR AUTOMATED MAINTENANCE AND OPTIMIZATION OF SWIMMING POOLS”, the contents of which are incorporated herein by the way of reference.

### BACKGROUND

### Description of the Related Art

The embodiments herein relate generally to automated maintenance systems for swimming pools. The embodiments herein a particularly related to a system and method that leverages real-time occupancy detection using computer vision to dynamically optimize the maintenance routines for swimming pools, including water pumping, filtering, and chemical dosing.

### Description of the Related Art

Traditional swimming pool maintenance relies on static schedules for pumping, filtering, and chemical treatment, which does not account for actual pool usage. This approach often leads to the inefficient use of energy and chemicals, increasing operational costs and environmental impact. Moreover, fixed maintenance schedules fail to ensure optimal water quality, which can vary with fluctuating pool usage, potentially compromising swimmer safety and satisfaction.

The existing systems lack the capability to adapt to real-time changes in pool occupancy, resulting in either over-maintenance or under-maintenance, both of which are inefficient and costly. Furthermore, the absence of real-time data integration in pool maintenance processes prevents the optimization of resource use and operational efficiency.

Hence, there is a clear need for an automated, intelligent system capable of accurately detecting real-time pool occupancy and adjusting maintenance tasks accordingly. Such a system would not only improve the efficiency of resource use but also enable the safety and satisfaction of pool users, while reducing the environmental impact of pool operations.

The above-mentioned shortcomings, disadvantages and problems are addressed herein, and which will be understood by reading and studying the following specification.

### OBJECT OF THE EMBODIMENTS HEREIN

The primary object of the embodiments herein is to provide a system and method for the automated maintenance and optimization of swimming pools, leveraging real-time occupancy data obtained through advanced computer vision techniques.

Another object of the embodiments herein is to deploy advanced computer vision technologies for accurately detecting the number of swimmers in the pool in real time, thereby providing a basis for all subsequent maintenance adjustments.

Yet another object of the embodiments herein is to dynamically adjust the chemical dosing, water pumping, and filtration operations based on the detected occupancy, ensuring that the pool maintenance is always aligned with the current usage.

Yet another object of the embodiments herein is to optimize the use of disinfectants and other pool chemicals by calibrating dosages according to real-time data, thus preventing overuse or underuse, enhancing water quality, and reducing waste.

Yet another object of the embodiments herein is to reduce energy consumption by adjusting the operation of pumps and filtration systems to suit the actual needs based on pool occupancy, contributing to lower operational costs and environmental sustainability.

Yet another object of the embodiments herein is to ensure that the water quality is consistently maintained at an optimal level for safety and comfort, adjusted dynamically in response to changes in pool usage patterns.

Yet another object of the embodiments herein is to design the system for easy integration with existing pool infrastructure, allowing for retrofitting into different types of pools without the need for extensive modifications.

Yet another object of the embodiments herein is to utilize the collected data for generating actionable insights, enabling pool operators to make informed decisions regarding pool maintenance and management.

Yet another object of the embodiments herein is to maintain high standards of swimmer safety and regulatory compliance by ensuring precise control over water quality and pool conditions, thereby minimizing health risks associated with improper chemical balances.

These and other objects and advantages of the embodiments herein will become readily apparent from the following summary and the detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The various embodiments herein provide a system and method for optimizing swimming pool maintenance by using advanced computer vision and machine learning technologies to detect real-time occupancy. The system dynamically adjusts maintenance tasks such as chemical dosing, water pumping, and filtering based on the number of people detected in the pool, thereby optimizing resource usage and maintaining optimal pool conditions.

According to one embodiment herein, the system is designed to optimize pool operations using real-time data on pool occupancy obtained via advanced computer vision. This system comprises a plurality of interconnected functional modules that work in harmony to adjust maintenance tasks such as chemical dosing, water pumping, and filtration based on the dynamic needs of the pool. The central part to this architecture is the integration of high-definition cameras, an image processing unit equipped with machine learning, a control unit for operational management, and various actuation systems for executing maintenance adjustments. The design emphasizes scalability and adaptability, allowing for integration with existing pool infrastructure while ensuring that all adjustments are data-driven and precise.

According to one embodiment herein, the method for automated swimming pool maintenance revolves around using real-time data to dynamically adjust pool maintenance procedures to ensure optimal water quality and resource efficiency. High-definition cameras installed around the pool capture continuous video footage, which is processed by an advanced image processing unit utilizing machine learning algorithms to accurately detect the number of swimmers. This occupancy data is then fed into a control unit, which adjusts the rates of chemical dosing and water pumping accordingly. Chemical and water quality sensors provide feedback to the control unit, which uses this information to make real-time adjustments, ensuring that the chemical balance and water clarity are maintained within optimal parameters. This method significantly improves the efficiency of pool maintenance tasks, reduces costs, and enhances swimmer safety by ensuring appropriate water treatment based on actual usage.

According to one embodiment herein, a system provided for automated maintenance and optimization of swimming pools comprises: a camera system configured to capture real-time video footage of the swimming pool area; an image processing unit operatively connected to the camera system, the image processing unit comprising a machine learning module configured to analyze the video footage to detect and count swimmers in the pool; a control unit configured to receive occupancy data from the image processing unit and dynamically adjust the operations of a chemical dosing module through its set-up values and a water pumping and filtration system based on the occupancy data; a machine learning module configured to analyze the video footage to detect and differentiate humans inside the water from other objects in real-time, and to determine the number of occupants with high accuracy; a chemical dosing module operatively connected to the control unit, the chemical dosing module configured to regulate the release of pool chemicals based on real-time feedback; a water pumping and filtration system operatively connected to the control unit, the system configured to regulate water circulation and filtration rates based on occupancy data; and a plurality of feedback and monitoring sensors operatively connected to the control unit, the sensors configured to monitor water quality parameters and provide real-time data to the control unit for further optimization.

According to one embodiment herein, the camera system comprises a plurality of high-definition cameras positioned around the pool, the cameras being weather-resistant and capable of low-light imaging to ensure consistent data capture under varying environmental conditions.

According to one embodiment herein, the image processing unit utilizes machine learning algorithms trained to differentiate between swimmers and non-swimmer objects, and the machine learning module is configured to be updated periodically for improved accuracy.

According to one embodiment herein, the control unit includes a user interface that allows pool operators to monitor system status, adjust operational parameters manually, and access historical data for analysis.

According to one embodiment herein, the chemical dosing module comprises a plurality of actuators and dosing pumps configured to adjust chemical levels based on occupancy data and feedback from water quality sensors, maintaining optimal chemical balance in the pool.

According to one embodiment herein, the water pumping and filtration system comprises variable-speed pumps and filtration units configured to dynamically adjust flow rates and filtration cycles based on real-time occupancy data.

According to one embodiment herein, the feedback and monitoring sensors include sensors for monitoring pH levels, chlorine concentration, and turbidity, the sensors providing continuous feedback to the control unit for real-time adjustments to chemical dosing and filtration operations.

According to one embodiment herein, a method is provided for automated maintenance and optimization of swimming pools comprises: continuously capturing real-time video footage of the pool area using a camera system; analyzing the captured video footage using machine learning algorithms in an image processing unit to detect and count swimmers in the pool; determining real-time pool occupancy based on the analyzed video data; dynamically adjusting chemical set-up values based on the determined pool occupancy to maintain optimal water quality; regulating water pumping rates and filtration processes based on the determined pool occupancy to optimize energy efficiency; continuously monitoring water quality parameters such as pH, chlorine levels, and turbidity using feedback and monitoring sensors; performing real-time adjustments to chemical dosing and water pumping informed by feedback from the monitoring sensors; and, recording operational data and adjustments for ongoing monitoring and future analysis.

According to one embodiment herein, the step of capturing real-time video footage involves using a camera system comprising multiple high-definition, weather-resistant cameras capable of capturing comprehensive visual data under varying environmental conditions.

According to one embodiment herein, the step of analyzing video footage involves using an image processing unit equipped with machine learning algorithms trained to differentiate swimmers from non-swimmer objects and to accurately count the number of swimmers in the pool.

According to one embodiment herein, the step of determining pool occupancy provides real-time data to a control unit, which adjusts maintenance operations such as chemical disinfectant set-up levels and water pumping.

According to one embodiment herein, the step of dynamically adjusting chemical disinfectant set-up levels involves a chemical dosing module configured to release precise amounts of chemicals based on real-time occupancy data and feedback from water quality sensors.

According to one embodiment herein, the step of regulating water pumping and filtration involves adjusting the operation of variable-speed pumps and filtration units based on real-time occupancy data to optimize energy efficiency.

According to one embodiment herein, the step of monitoring water quality parameters involves using a plurality of sensors configured to measure pH, chlorine concentration, and turbidity, and providing this data to the control unit for real-time adjustments.

According to one embodiment herein, the step of recording operational data involves storing historical data on occupancy, chemical dosing, and water quality, enabling pool operators to analyze trends and optimize future maintenance schedules.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates the functional block diagram of a system and method for optimizing swimming pool maintenance, according to one embodiment herein.

FIG. 2 illustrates the process flow involved in the method for optimizing swimming pool maintenance, according to one embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments herein provide a system and method for optimizing swimming pool maintenance by using advanced computer vision and machine learning technologies to detect real-time occupancy. The system dynamically adjusts maintenance tasks such as chemical dosing, water pumping, and filtering based on the number of people detected in the pool, thereby optimizing resource usage and maintaining optimal pool conditions.

According to one embodiment herein, the system is designed to optimize pool operations using real-time data on pool occupancy obtained via advanced computer vision. This system comprises a plurality of interconnected functional modules that work in harmony to adjust maintenance tasks such as chemical dosing, water pumping, and filtration based on the dynamic needs of the pool. The central part to this architecture is the integration of high-definition cameras, an image processing unit equipped with machine learning, a control unit for operational management, and various actuation systems for executing maintenance adjustments. The design emphasizes scalability and adaptability, allowing for integration with existing pool infrastructure while ensuring that all adjustments are data-driven and precise.

According to one embodiment herein, a camera system comprises a plurality of multiple high-definition, weather-resistant cameras strategically positioned around the pool to capture comprehensive visual data. These cameras are equipped with capabilities for low-light imaging and are robust enough to operate under various environmental conditions, ensuring consistent data capture. The video feed from these cameras is relayed in real-time to the image processing unit and forms the foundational data layer upon for occupancy detection.

According to one embodiment herein, an image processing unit is equipped with powerful processing hardware (such as GPUs) to handle the computation-heavy tasks of video data analysis. This unit uses advanced image recognition algorithms developed on machine learning principles to analyze the footage provided by the cameras. The algorithms are trained to accurately identify human figures within the pool area and count them, differentiating between swimmers and non-swimmer objects such as debris or pool toys.

According to one embodiment herein, a machine learning module is trained to detect and differentiate humans from other objects in real-time. The machine learning module is embedded within the image processing unit. The module analyzes patterns in the video data to accurately determine the number of occupants by utilizing deep learning techniques. The module is regularly updated and retrained to adapt to new data and environmental changes, ensuring its accuracy remains high under all operating conditions.

According to one embodiment herein, a control unit serves as the system's command center. It is configured to receive analyzed data from the image processor and based on this data, it executes logic and control algorithms to adjust the operation of the chemical dosing system, water pumps, and filtration systems. The control unit is equipped with a user-friendly interface that allows pool operators to monitor system status, adjust parameters manually if needed, and access historical data for further analysis.

According to one embodiment herein, a chemical dosing module is configured to automatically adjust the quantity of chemicals released into the pool based on real-time occupancy data. This module includes a plurality of actuators and dosing pumps that are controlled by the control unit, which modulate the release of chemicals like Chlorine to maintain optimal water quality. Sensors within the pool provide feedback on chemical levels, which is utilized by the control unit to refine dosing accuracy.

According to one embodiment herein, a water pumping and filtration system comprises the pool's water pumps and filtration units, wherein their operation is dynamically adjusted by the control unit based on occupancy data. The system enables an efficient use of energy and maintains water clarity and cleanliness in the pool by modulating the operation of a plurality of these systems. A plurality of variable speed drives is used to adjust pump speeds and filtration rates, providing a flexible response to detected changes in pool use.

According to one embodiment herein, a plurality of feedback and monitoring sensors are integrated throughout the pool, including sensors to monitor water quality parameters such as pH, Chlorine concentration, and turbidity. These sensors continuously feed data back to the control unit, allowing for real-time adjustments to maintenance processes and ensuring that all interventions are based on the most current data. This feedback loop is crucial for the system's ability to maintain optimal pool conditions at all times.

According to one embodiment herein, the method for automated swimming pool maintenance revolves around using real-time data to dynamically adjust pool maintenance procedures to ensure optimal water quality and resource efficiency. High-definition cameras installed around the pool capture continuous video footage, which is processed by an advanced image processing unit utilizing machine learning algorithms to accurately detect the number of swimmers. This occupancy data is then fed into a control unit, which adjusts the rates of chemical dosing and water pumping accordingly. Chemical and water quality sensors provide feedback to the control unit, which uses this information to make real-time adjustments, ensuring that the chemical balance and water clarity are maintained within optimal parameters. This method significantly improves the efficiency of pool maintenance tasks, reduces costs, and enhances swimmer safety by ensuring appropriate water treatment based on actual usage.

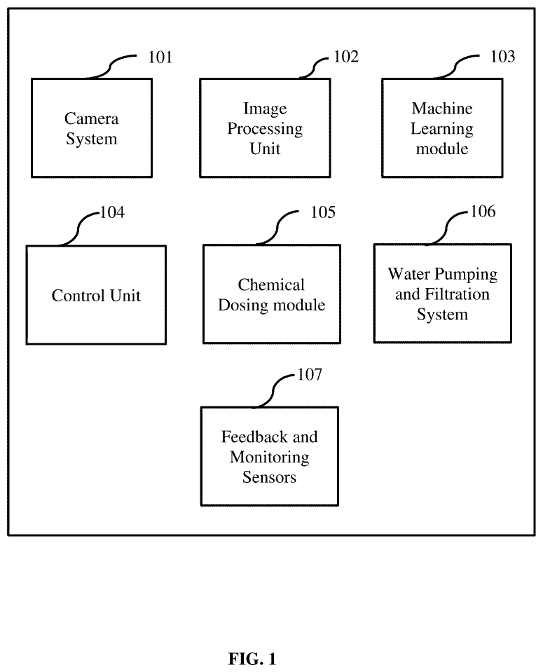

FIG. 1 illustrates the functional block diagram of a system and method for optimizing swimming pool maintenance. The system comprises a camera system 101, an image processing unit 102, a machine learning module 103, a control unit 104, a chemical dosing module 105, a water pumping and filtration system 106, and a plurality of feedback and monitoring sensors 107.

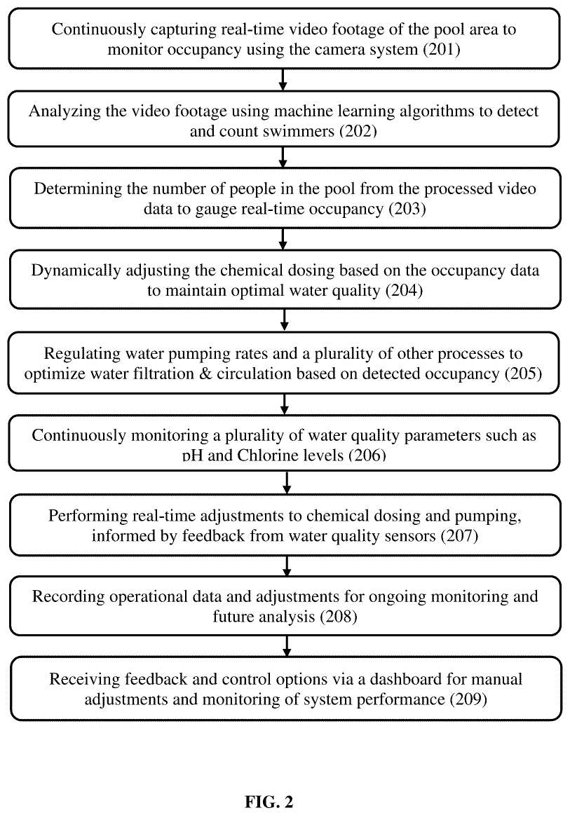

FIG. 2 illustrates the process flow involved in the method for optimizing swimming pool maintenance. The method includes the following steps: continuously capturing real-time video footage of the pool area to monitor occupancy using the camera system (201); analyzing the video footage using machine learning algorithms to detect and count swimmers (202); determining the number of people in the pool from the processed video data to gauge real-time occupancy (203); dynamically adjusting the chemical dosing based on the occupancy data to maintain optimal water quality (204); regulating water pumping rates and a plurality of other processes to optimize water filtration and circulation based on detected occupancy (205); continuously monitoring a plurality of water quality parameters such as pH and Chlorine levels (206); performing real-time adjustments to chemical dosing and pumping, informed by feedback from water quality sensors (207); recording operational data and adjustments for ongoing monitoring and future analysis (208); and, receiving feedback and control options via a dashboard for manual adjustments and monitoring of system performance (209).

The various embodiments herein provide a system and method for optimizing swimming pool maintenance by using advanced computer vision and machine learning technologies to detect real-time occupancy. The system dynamically adjusts maintenance tasks such as chemical dosing, water pumping, and filtering based on the number of people detected in the pool, thereby optimizing resource usage and maintaining optimal pool conditions. The embodiments significantly enhance both the efficiency and effectiveness of pool management. By utilizing real-time occupancy data gathered through advanced computer vision, the system dynamically adjusts chemical dosing, water pumping, and filtration activities, ensuring optimal resource use tailored to actual pool usage. This precision in maintenance conserves energy and reduces chemical waste, thereby lowering operational costs. This also enables a lesser dosing of disinfectants as compared to conventional systems, thereby increasing the water quality since less disinfection by-products are generated. The system is also configured to maintain the level of disinfectants at the optimum level (above the compliances-approved threshold) and avoids the occurrence of biological pollution. Additionally, the system's ability to continuously adapt to changing conditions in real-time enhances the sustainability of pool operations, minimizes the environmental impact, and ensures compliance with health regulations. The integration of machine learning and feedback mechanisms facilitates continuous learning and improvement of the system, making it increasingly effective over time. Furthermore, the capability to log and analyze operational data enables pool operators to make informed decisions, further optimizing maintenance schedules and practices. Overall, this system represents a significant advancement in swimming pool technology, offering a smarter, more responsive approach to pool maintenance that benefits both operators and users alike.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

It is also to be understood that the following claims are intended to cover all of the generic and specific features of the embodiments described herein and all the statements of the scope of the embodiments which as a matter of language might be said to fall there between.

What is claimed is:

1. A system for automated maintenance and optimization of swimming pools, comprising:
a camera system configured to capture real-time video footage of the swimming pool area;
an image processing unit operatively connected to the camera system, the image processing unit comprising a machine learning module, the image processing unit configured to analyze the video footage to detect and count swimmers in the pool;
a control unit configured to receive occupancy data from the image processing unit and dynamically adjust the operations of a chemical dosing module through its set-up values and a water pumping and filtration system based on the occupancy data;
a machine learning module configured to analyze the video footage to detect and differentiate humans inside the water from other objects in real-time, and to determine the number of occupants with high accuracy;
a chemical dosing module operatively connected to the control unit, the chemical dosing module configured to regulate the release of pool chemicals based on real-time feedback;
a water pumping and filtration system operatively connected to the control unit, the system configured to regulate water circulation and filtration rates based on occupancy data; and
a plurality of feedback and monitoring sensors operatively connected to the control unit, the sensors configured to monitor water quality parameters and provide real-time data to the control unit for further optimization.

2. The system according to claim 1, wherein the camera system comprises a plurality of high-definition cameras positioned around the pool, the cameras being weather-resistant and capable of low-light imaging to ensure consistent data capture under varying environmental conditions.

3. The system according to claim 1, wherein the image processing unit utilizes machine learning algorithms trained to differentiate between swimmers and non-swimmer objects, and the machine learning module is configured to be updated periodically for improved accuracy.

4. The system according to claim 1, wherein the control unit includes a user interface that allows pool operators to monitor system status, adjust operational parameters manually, and access historical data for analysis.

5. The system according to claim 1, wherein the chemical dosing module comprises a plurality of actuators and dosing pumps configured to adjust chemical levels based on occupancy data and feedback from water quality sensors, maintaining optimal chemical balance in the pool.

6. The system according to claim 1, wherein the water pumping and filtration system comprises variable-speed pumps and filtration units configured to dynamically adjust flow rates and filtration cycles based on real-time occupancy data.

7. The system according to claim 1, wherein the feedback and monitoring sensors include sensors for monitoring pH levels, chlorine concentration, and turbidity, the sensors providing continuous feedback to the control unit for real-time adjustments to chemical dosing and filtration operations.

8. A method for automated maintenance and optimization of swimming pools, comprising:
continuously capturing real-time video footage of the pool area using a camera system;
analyzing the captured video footage using machine learning algorithms in an image processing unit to detect and count swimmers in the pool;
determining real-time pool occupancy based on the analyzed video data;
dynamically adjusting chemical set-up values based on the determined pool occupancy to maintain optimal water quality;
regulating water pumping rates and filtration processes based on the determined pool occupancy to optimize energy efficiency;
continuously monitoring water quality parameters such as pH, chlorine levels, and turbidity using feedback and monitoring sensors;
performing real-time adjustments to chemical dosing and water pumping informed by feedback from the monitoring sensors; and
recording operational data and adjustments for ongoing monitoring and future analysis.

9. The method according to claim 8, wherein the step of capturing real-time video footage involves using a camera system comprising multiple high-definition, weather-resistant cameras capable of capturing comprehensive visual data under varying environmental conditions.

10. The method according to claim 8, wherein the step of analyzing video footage involves using an image processing unit equipped with machine learning algorithms trained to differentiate swimmers from non-swimmer objects and to accurately count the number of swimmers in the pool.

11. The method according to claim 8, wherein the step of determining pool occupancy provides real-time data to a control unit, which adjusts maintenance operations such as chemical disinfectant set-up levels and water pumping.

12. The method according to claim 8, wherein the step of dynamically adjusting chemical disinfectant set-up levels involves a chemical dosing module configured to release precise amounts of chemicals based on real-time occupancy data and feedback from water quality sensors.

13. The method according to claim 8, wherein the step of regulating water pumping and filtration involves adjusting the operation of variable-speed pumps and filtration units based on real-time occupancy data to optimize energy efficiency.

14. The method according to claim 8, wherein the step of monitoring water quality parameters involves using a plurality of sensors configured to measure pH, chlorine concentration, and turbidity, and providing this data to the control unit for real-time adjustments.

15. The method of claim 8, wherein the step of recording operational data involves storing historical data on occupancy, chemical dosing, and water quality, enabling pool operators to analyze trends and optimize future maintenance schedules.
